(19) United States
(12) Patent Application Publication
(10) Pub. No.: US 2008/0163524 A1
(43) Pub. Date: Jul. 10, 2008

(54) PICTURE FRAME

(75) Inventors: Joshua Michael Broehl, Worthington, OH (US); James Huang Lua, Columbus, OH (US)

Correspondence Address: KREMBLAS, FOSTER, PHILLIPS & POLLICK, 7632 SLATE RIDGE BOULEVARD, REYNOLDSBURG, OH, 43068, US

(73) Assignee: WILTON INDUSTRIES, INC., Woodridge, IL (US)

(21) Appl. No.: 12/045,793

(22) Filed: Mar. 11, 2008

Related U.S. Application Data
(63) Continuation-in-part of application No. 11/355,844, filed on Feb. 16, 2006.
Application No. 11/355,844 is a continuation-in-part of application No. 11/937,596, filed on Nov. 9, 2007.

(51) Int. Cl. A47G 1/06; G09F 3/00; G01B 3/00

(52) U.S. Cl. 40/299.01; 40/700; 40/745; 40/765; 40/768; 40/722; 33/563

(57) ABSTRACT

An improved picture frame having an open display pocket mounted behind a viewing aperture for changing the picture displayed within the frame. An easel is mounted to the rear of the frame for supporting the frame in either a portrait or landscape orientation. A hanging apparatus is provided for mounting the picture frame to a wall. A plate with radially outwardly-facing substantially circular cylindrical surfaces attaches to the wall. A hanger mounts to the frame and has radially inwardly-facing substantially circular cylindrical surfaces seating against the cylindrical surfaces of the plate. The plate has a first lip extending radially outwardly of the cylindrical surfaces of the plate and the hanger has a second lip extending radially outwardly of the cylindrical surfaces of the hanger.

### BACKGROUND OF THE INVENTION

1. Field of the Invention

This invention relates generally to the field of picture frames, and more particularly to a picture frame having a display pocket, a storage compartment, a hanging apparatus, and an easel.

2. Description of the Related Art

Many conventional picture frames have a border element surrounding a transparent viewing pane, such as a glass sheet. A backer board is positioned behind the viewing pane and is secured to the border element by pivot tabs. A generally triangular or necktie-shaped easel is mounted to the backer board, and, optionally, a framing mat is positioned between the backer board and the viewing pane. For rectangular frames, the easel allows the frame to stand upright in either a portrait or a landscape orientation.

In order to insert a picture into a frame such as the one described, the pivot tabs are rotated to an open position, the backer board is removed, and a picture is placed flat against the viewing pane. The framing mat is centered, the backer board is replaced, and the pivot tabs are moved back to a closed position. This process can be time consuming and cumbersome, and often must be repeated in order to establish proper alignment of the picture due to the tendency of pictures to shift relative to the viewing pane when the backer board is being replaced.

It is therefore desirable to have a means for quickly and easily changing the picture displayed in a frame while maintaining proper orientation of the picture, and which also retains the ability to support the frame in either a portrait or a landscape orientation.

### BRIEF SUMMARY OF THE INVENTION

In accordance with the present invention, there is provided in a first embodiment a border element, a viewing pane, a display pocket, a storage compartment, and a peripheral easel. The border element and the viewing pane are similar to those used for conventional picture frame applications, such as a wooden, rectangular border and a glass pane. The border element has a primary viewing aperture, and the viewing pane is preferably mounted behind the viewing aperture. The display pocket is mounted to the rear of the border element behind the viewing pane to form a narrow slot between the display pocket and the rear surface of the viewing pane. In order to display a picture within the frame, the picture is slid into the open top of the slot. The picture can be removed, and another inserted in its place in a similar manner.

The storage compartment preferably extends from the rear of the display pocket to form a chamber between the rear wall of the compartment and the rear wall of the display pocket. Preferably, the chamber is large enough to hold 5-10 pictures for convenient storage while the pictures are not being displayed in the display pocket.

In an alternative embodiment of the invention, a backing mat having at least one secondary viewing aperture that is smaller than the primary aperture flatly abuts the rear surface of the viewing pane. A display pocket is mounted to the rear of the backing mat, covering the secondary viewing aperture and forming a slot between the pocket and the rear surfaces of both the backing mat and the viewing pane.

The peripheral easel preferably has an L-shaped bracket with two ends. Each end of the bracket is pivotably mounted to the rear of the border element by hinges, and each hinge preferably has an axis that is collinear with the other hinge's axis. The bracket is preferably positioned slightly within the periphery of the border element and does not traverse or interfere with the display pocket or the storage compartment. The bracket can be pivoted to an extended position for supporting the frame in either a portrait or a landscape orientation, and can also be pivoted to a retracted position for hanging the frame on a wall.

### BRIEF DESCRIPTION OF THE SEVERAL VIEWS OF THE DRAWINGS

FIG. 1 is a rear perspective exploded view illustrating a preferred embodiment of a picture frame of the present invention.

FIG. 2 is a rear perspective view illustrating the embodiment of FIG. 1, in an assembled state.

FIG. 3 is a rear perspective view illustrating the embodiment of FIG. 1, with a picture being inserted into the display pocket.

FIG. 4 is a side cross-sectional schematic view illustrating an embodiment of the storage/display member of FIG. 1 with round protrusions extending from the pocket wall of the display pocket.

FIG. 5 is a side cross-sectional schematic view illustrating an alternative embodiment of the storage/display member of FIG. 1 with angled tabs extending from the pocket wall of the display pocket.

FIG. 6 is a side cross-sectional schematic view illustrating an alternative embodiment of the storage/display member of FIG. 1 with spring-loaded fingers extending from the pocket wall of the display pocket.

FIG. 7 is a rear schematic view illustrating an embodiment of a picture frame of the present invention with a single border element, multiple primary viewing apertures, and multiple storage/display members.

FIG. 8 is a rear schematic view illustrating an embodiment of a picture frame of the present invention with a single border element, a single primary viewing aperture, a single backing mat, multiple secondary viewing apertures, and multiple storage/display members.

FIG. 9 is a rear perspective view illustrating the embodiment of FIG. 1 with an L-shaped easel supporting the border element in an upright, portrait orientation.

FIG. 10 is a rear perspective view illustrating the embodiment of FIG. 1 with an L-shaped easel supporting the border element in an upright, landscape orientation.

FIG. 11 is a rear perspective view illustrating an alternative embodiment of a picture frame of the present invention with a U-shaped easel in a retracted position.

FIG. 12 is a rear perspective view illustrating the embodiment of FIG. 11 with the U-shaped easel in an extended position.

FIG. 13 is a rear perspective view illustrating an alternative embodiment of a picture frame of the present invention with a straight, elongated easel in a retracted position.

FIG. 14 is a rear perspective view illustrating the embodiment of FIG. 13 with the straight, elongated easel in an extended position.

FIG. 15 is a rear exploded perspective view illustrating an alternative embodiment of a picture frame of the present invention incorporating a backing mat.

FIG. 16 is a rear perspective exploded view illustrating an alternative embodiment of a picture frame of the present invention incorporating a pivoting backer board.

FIG. 17 is a front perspective view illustrating the embodiment of FIG. 16 incorporating a pivoting backer board, with a picture being inserted therein.

FIG. 18 is a rear perspective view illustrating the embodiment of FIG. 16 incorporating a pivoting backer board, with a picture being inserted therein.

FIG. 19 is a rear perspective exploded view illustrating an alternative embodiment of a picture frame of the present invention incorporating a CD holder.

FIG. 20 is a partial rear perspective exploded view illustrating the embodiment of FIG. 19 incorporating an alternative hanger.

FIG. 21 is an exploded front perspective view illustrating an embodiment of a hanging apparatus of the present invention.

FIG. 22 is an exploded rear perspective view illustrating the embodiment of FIG. 21.

FIG. 23 is a front elevational view illustrating the embodiment of FIG. 21, as assembled.

FIG. 24 is a side elevational view in section illustrating the embodiment of FIG. 23 through the line 24-24 of FIG. 23.

FIG. 25 is a rear perspective view illustrating a picture frame with one embodiment of a hanger of the present invention mounted thereto.

FIG. 26 is a rear elevational view illustrating the plate of the hanging apparatus of FIG. 21.

FIG. 27 is a front elevational view illustrating the plate of the hanging apparatus of FIG. 21.

FIG. 28 is a side elevational view illustrating the plate of FIG. 26 through the line 28-28 of FIG. 26.

FIG. 29 is a front perspective exploded view illustrating an alternative embodiment of a hanging apparatus of the present invention.

FIG. 30 is a rear perspective exploded view illustrating the embodiment of FIG. 29.

FIG. 31 is a rear perspective view illustrating a frame with the hanger of the hanging apparatus of FIG. 29 mounted thereto.

FIG. 32 is a side elevational view in section illustrating a portion of the frame of FIG. 31 through the line 32-32.

FIG. 33 is an exploded front perspective view illustrating an alternative embodiment of a hanging apparatus of the present invention.

FIG. 34 is an exploded rear perspective view illustrating the embodiment of FIG. 33.

FIG. 35 is a side elevational view in section illustrating a portion of the frame of FIG. 36 through the line 35-35 of FIG. 36.

FIG. 36 is a rear perspective view illustrating an embodiment of a frame with a hanger of the hanging apparatus of FIG. 33 mounted thereto.

FIG. 37 is a front elevational view illustrating an alternative embodiment of a plate of a hanging apparatus.

FIG. 38 is a rear view in perspective illustrating the plate of FIG. 37.

FIG. 39 is a side elevational view illustrating the plate of FIG. 37 through the line 39-39 of FIG. 37.

FIG. 40 is a side elevational view illustrating the plate of FIG. 37.

FIG. 41 is a front elevational view illustrating a hanger for use in a hanging apparatus with the plate of FIG. 37.

FIG. 42 is a rear elevational view illustrating the hanger of FIG. 41.

FIG. 43 is a front perspective view illustrating the hanger of FIG. 41.

FIG. 44 is a side elevational view illustrating the hanger of FIG. 41.

FIG. 45 is a schematic view of an alternative embodiment of a hanging apparatus of the present invention.

FIG. 46 is a front perspective view illustrating an embodiment of a backing mat of the present invention.

FIG. 47 is a front view an embodiment of a hanging template of the present invention.

In describing the preferred embodiment of the invention which is illustrated in the drawings, specific terminology will be resorted to for the sake of clarity. However, it is not intended that the invention be limited to the specific terms so selected and it is to be understood that each specific term should be broadly interpreted and includes all technical equivalents which operate in a similar manner to accomplish a similar purpose. For example, the term “connected” as used herein is not limited to direct connection, but includes connections through other elements.

### DETAILED DESCRIPTION OF THE INVENTION

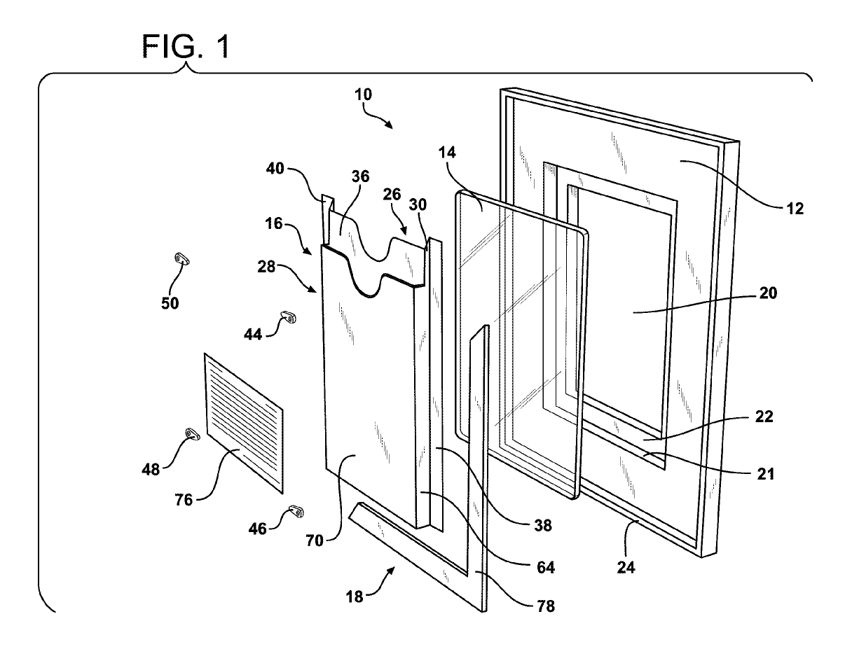

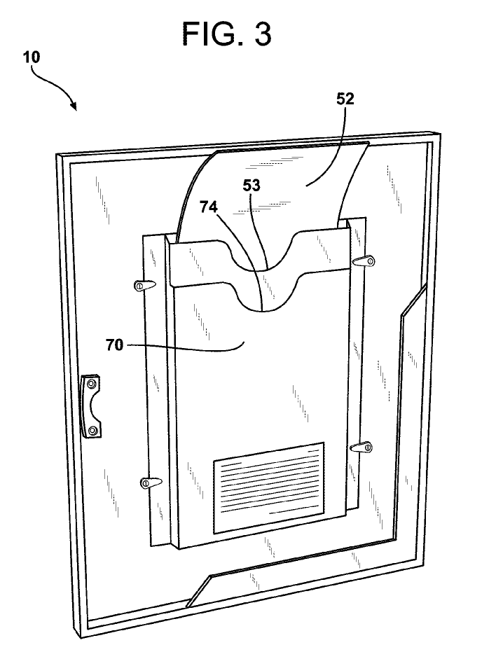

Referring to FIGS. 1-4, the frame 10 has a border element 12 and a viewing pane 14 similar in shape and size to those used in many conventional picture frame applications. Additionally, the frame has a storage/display member 16 and a peripheral easel 18. For the sake of convenience and clarity, terms such as “front,” “rear,” “top,” “height,” and “width” will be used herein to describe the relative placement and orientation of various components of the invention, each with respect to the orientation of the border element 12 as it appears in FIG. 1.

In the embodiment illustrated in FIG. 1, the border element 12 is a rectangular body having a rectangular primary viewing aperture 20. A rectangular shoulder 21 defines a mounting recess 22 in the rear surface of the border element 12 adjacent the primary viewing aperture 20. A mounting lip 24 (discussed in greater detail below) extends rearward a short distance from the periphery of the border element 12. The border element 12 is preferably fabricated from wood or metal, although all sufficiently durable materials, including, but not limited to, aluminum, magnesium, stainless steel, and plastic, are also contemplated.

The viewing pane 14 is preferably a rectangular piece of glass having a height and a width that are substantially equal to the height and the width of the mounting recess 22. The thickness of the pane 14 is less than the depth of the recess 22, and is preferably only slightly less. The viewing pane 14 preferably fits snugly within the recess 22 parallel to the plane of the border element 12, and with its front surface abutting the rearward-facing interior surface of the shoulder 21. Although the pane 14 is preferably made from glass having non-glare and/or ultraviolet light-blocking properties, all other substantially transparent materials, including, but not limited to, polycarbonate and acrylic, are also contemplated.

Still referring to FIGS. 1-4, the storage/display member 16 is a unitary body having a display pocket 26 and a storage compartment 28. The display pocket 26 is a rectangular body having three adjoining sidewalls 30, 32, and 34 that extend forward from the edges of a pocket wall 36. The height and the width of the display pocket 26 are preferably substantially equal to the height and the width of the mounting recess 22. Mounting flanges 38 and 40 extend outwardly from the front edges of the two opposing sidewalls 30 and 34 and fit within the mounting recess 22 parallel to the plane of the border element 12. The thickness of the mounting flanges 38 and 40 is preferably equal to the difference between the depth of the mounting recess 22 and the thickness of the viewing pane 14.

The front surfaces of the flanges 38 and 40 flatly abut the rear surface of the viewing pane 14 to define a picture slot 42 between the front surface of the pocket wall 36 and the rear surface of the pane 14. Because there is no top wall facing the bottom sidewall 32, there is an opening into the slot 42 through which pictures can be inserted.

The rear surfaces of the flanges 38 and 40 are substantially flush with the rear surface 13 of the border element 12. Conventional pivot tabs 44, 46, 48, and 50 are mounted to the rear of the border element 12 on opposing sides of the mounting recess 22. The pivot tabs 44, 46, 48, and 50 rotate over the rear surfaces of the mounting flanges 38 and 40 for securing the display pocket 26 and the viewing pane 14 within the recess 22.

The picture slot 42 has a predetermined height, width, and thickness that make the slot capable of holding a single picture 52 for viewing through the primary viewing aperture 20. In the course of use, the picture 52 is inserted into the open top of the slot 42 and manually slid into position behind the viewing pane 14 with its viewable face seating against the pane 14. It is contemplated that either or both of the display pocket's sides can additionally or alternatively be open for accommodating the insertion of a picture into the slot 42. A finger notch 53 in the top edge of the pocket wall 36 allows convenient manual gripping and removal of pictures from the slot 42.

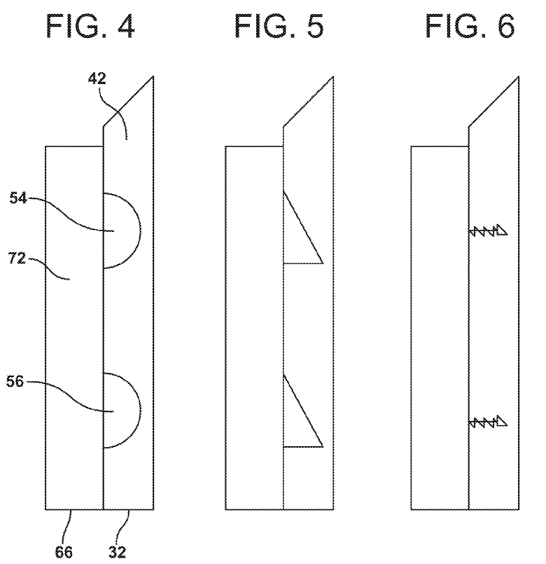

Referring to FIG. 4, four retention members 54, 56, 58, and 60 (the members 58 and 60 are not within view, but are preferably identical to members 54 and 56 that are shown) extend partially into the picture slot 42 from the pocket wall 36 of the pocket 26. The retention members 54, 56, 58, and 60 are protrusions that reduce the depth of the picture slot 42 to hold a displayed picture against the viewing pane 14, thereby preventing the picture from excessively bowing or curling. Although semi-circular or rounded protrusions are preferred, all other means for holding the picture in a similar manner, including, but not limited to angled tabs (see FIG. 5) or spring-loaded fingers (see FIG. 6) extending from the pocket wall 36 of the display pocket 26, are also contemplated.

The storage compartment 28 is a rectangular body having three adjoining sidewalls 64, 66, and 68 that extend forward from the edges of a compartment wall 70. The storage compartment 28 extends from the rear of the display pocket 26 to the wall 70 to form a storage chamber 72 therebetween. The storage chamber 72 preferably has a width that is equal to, or greater than, the display pocket 26, and a height that is preferably less than the height of the display pocket 26. The storage chamber 72 is preferably deep enough to accommodate a plurality of pictures, for example, in the range of 5-10, for convenient storage while the pictures are not on display in the display pocket 26. The pictures can be inserted through the top opening and are stacked in the chamber 72 in the manner of a deck of cards. Like the display pocket 26, a finger notch 74 in the top edge of the compartment wall 70 allows convenient removal of pictures from the storage chamber 72.

The storage/display member 16 is preferably fabricated from plastic, although all other sufficiently durable materials, including, but not limited to various rigid, semi-rigid, and flexible materials, are also contemplated. In particularly preferred embodiments, the storage/display member 16 can be made from any one of various metals or woods. Although it is preferred that the storage/display member 16 be a unitary body, it is contemplated that the display pocket 26 and the storage compartment 28 can be separate, independent bodies, positioned apart from one another on the rear of the border element 12, or positioned together after mounting one independent body to the other.

Referring to FIGS. 1-3, an optional adhesive memory label 76 is mounted to the rear surface of the storage compartment 28 for recording the contents of the storage chamber 72. For example, the label 76 can be used by a consumer to record a listing of each picture contained in the chamber 72, or announces a theme that is common to all of the stored pictures. The memory label 76 is preferably made from paper, although any material having a surface that can be written on in pen, pencil, or marker. For example an erasable material such as “dry-erase” plastic, could similarly be incorporated.

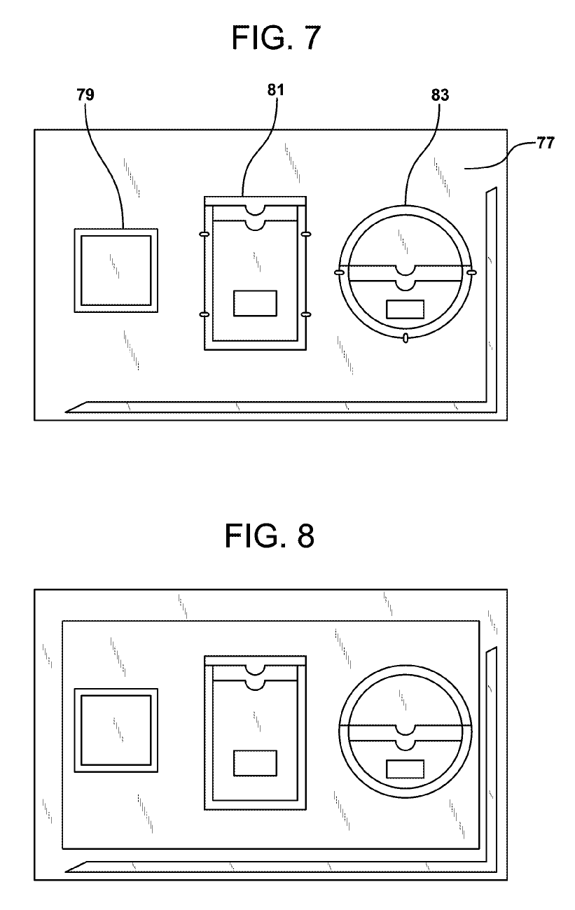

Embodiments of the invention are contemplated in which a single border element has a plurality of primary viewing apertures of various shapes and sizes, some or all of which having a storage/display member mounted behind them. For example, referring to FIG. 7, a single border element 77 is illustrated that has a small, square viewing aperture 79 with no storage/display member, a large, rectangular viewing aperture 81 with a storage/display member, and a medium, circular viewing aperture 83, also with a storage/display member. It is contemplated that the plurality of viewing apertures of a border element can be any combination of suitable sizes and/or shapes, each of which may or may not have its own storage compartment. It is also contemplated that there may be a plurality of display pockets and a single storage compartment mounted to the rear of a single border element. It should be noted, however, that there is preferably not more than one display pocket per primary viewing aperture, and preferably not more than one storage compartment mounted to a display pocket.

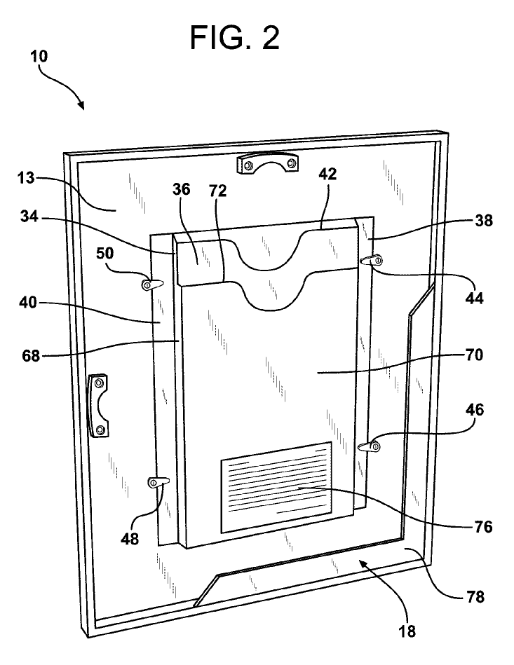

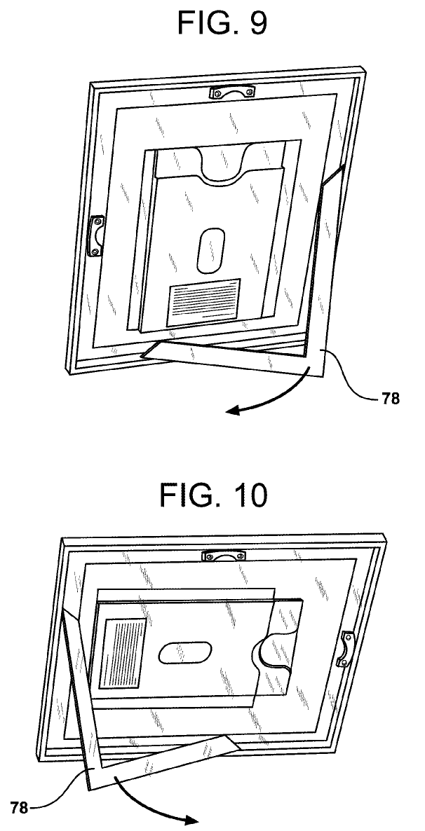

Referring back to FIGS. 1-3, the peripheral easel 18 has an L-shaped bracket 78 that can be pivotably mounted to the rear of the border element 12 by two conventional, collinear hinges (not within view). The hinges connect the two ends of the bracket 78 to adjacent sides of the border element 12, and their axes preferably extend substantially along a single line, thus allowing the bracket 78 to pivot about the axes between a retracted position (see FIG. 2) and an extended position (see FIGS. 9 and 10) without interfering with the operation of the storage/display member 16. A critical feature of the easel 18 is that it is able to lay against the rear surface of the border element 12 without traversing the storage/display member 16. Conventional hinge stops (not within view) prevent the easel 18 from pivoting outwardly beyond a stop angle of, for example, about 45 degrees, although stop angles that are lesser and greater are also contemplated. The easel 18 can support the border element 12 in an upright position when the border element 12 is in a portrait orientation (see FIG. 9) and a landscape orientation (see FIG. 10) when resting on a horizontal surface. For hanging the frame 10 from a wall or other vertical surface, the easel 18 is retracted.

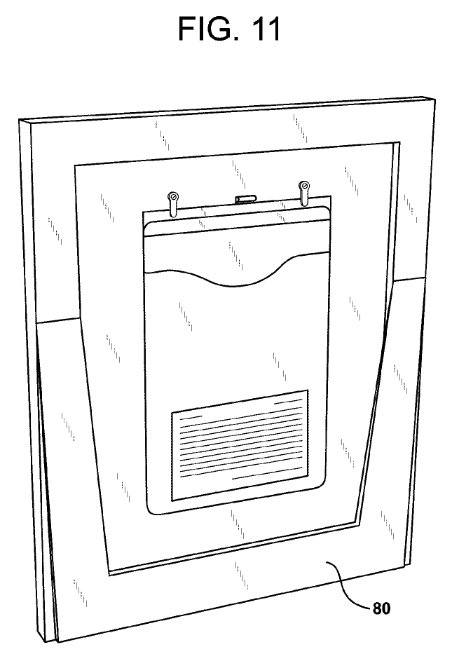

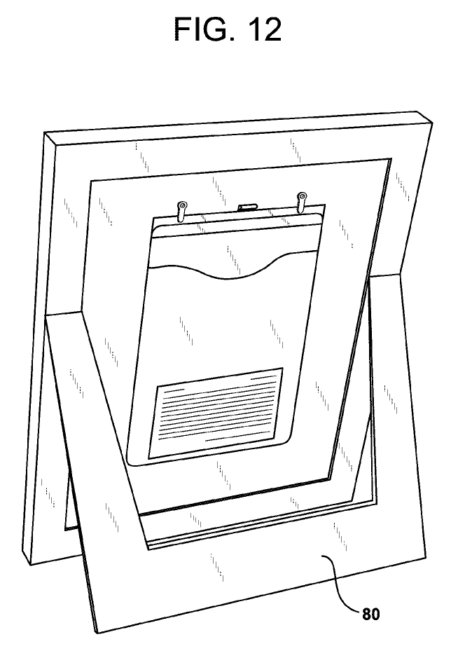

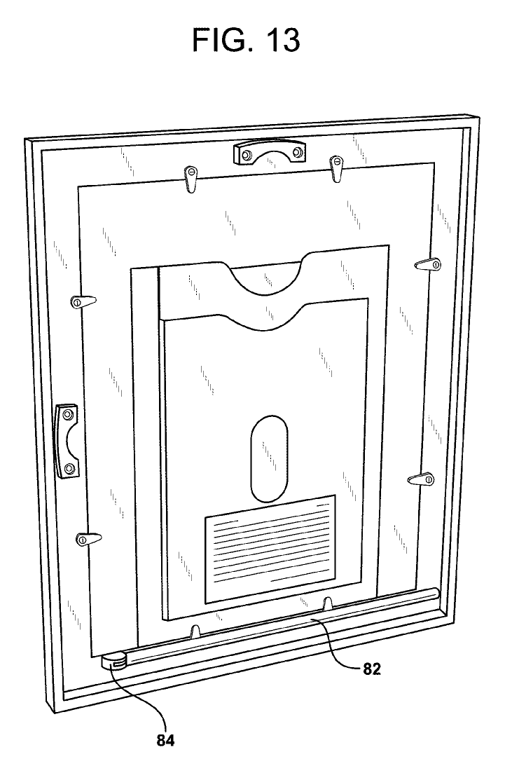

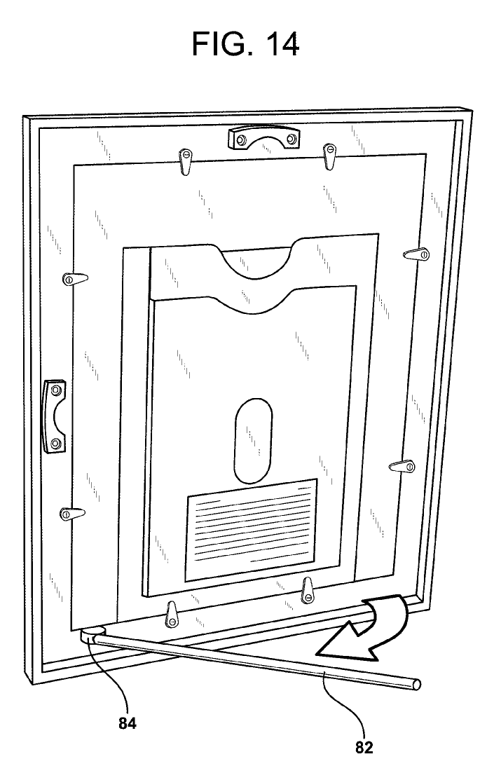

Although it is preferred that the peripheral easel 18 have an L-shaped bracket, it is contemplated that the bracket could be any other shape that achieves the purpose of supporting the frame in either a landscape or portrait orientation without interfering with or traversing the storage/display member 16. For example, referring to FIGS. 11 and 12, the bracket can be a U-shaped body 80 that is mounted to opposing sides of a border element. Referring to FIGS. 13 and 14, the bracket can alternatively be a straight, elongated body 82 that is pivotably mounted to a border element by a single hinge 84.

The mounting lip 24 of the border element 12 preferably extends rearward farther than the rear surface 13, the storage compartment 28 or the peripheral easel 18. Because of this feature, the frame 10 can be mounted to a vertical structure, such as a wall, with the rear surface of the mounting lip 24 minimally spaced from the surface of the structure, thus hiding the rear of the frame 10 from view and thereby providing a clean and pleasing appearance.

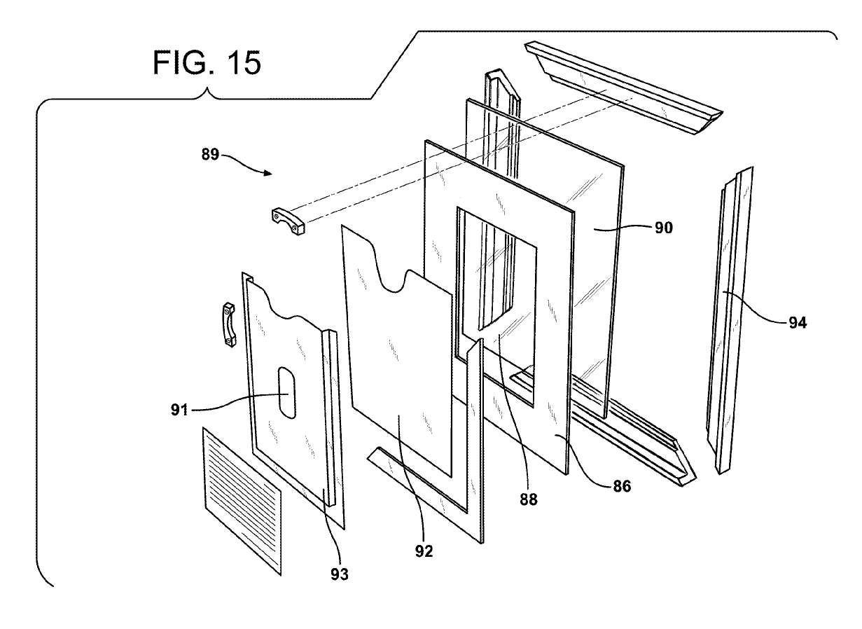

In an alternative embodiment of the invention, shown in FIG. 15, a rectangular, preferably opaque backing mat 86, having a secondary viewing aperture 88 that is smaller than the picture to be displayed in the frame 89, flatly abuts the viewing pane 90. The backing mat 86 is preferably formed of an acid-free and/or lignin-free material for aiding in the preservation of pictures displayed in the frame. The display pocket 92 is mounted to the rear of the preferably opaque backing mat 86, covering the secondary viewing aperture 88 and forming a picture slot between the pocket wall of the display pocket 92 and the rear surfaces of the backing mat 86 and the viewing pane 90. The display pocket 92 can be integral to the backing mat 86, or can be mounted with fasteners, such as glue, to the backing mat 86. A finger-push aperture 91 in the compartment wall of the storage compartment 93 allows insertion of a finger for manually lifting a picture out of the storage compartment 93.

Similar to the embodiment of the invention in FIGS. 1-3, it is contemplated that the backing mat of the FIG. 15 embodiment can have a plurality of secondary viewing apertures of different shapes and sizes, some or all of which have a storage/display member located behind them (see, e.g., FIG. 8). It is also contemplated that the viewing pane 90 can be omitted from the FIG. 15 embodiment, with the backing mat instead abutting the border element 94.

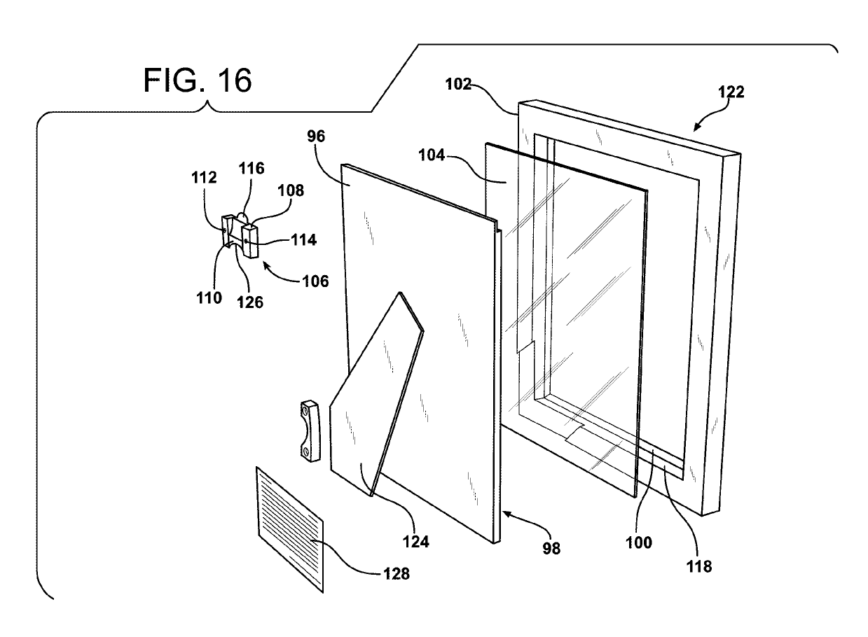

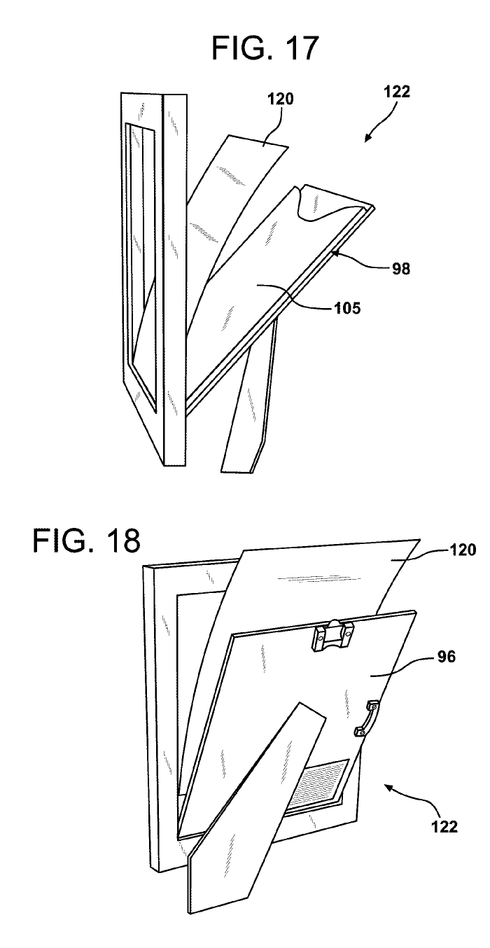

In another alternative embodiment of the invention, shown in FIGS. 16-18, a rectangular, preferably opaque backer board 96, having an interior storage compartment 98 extending from its front surface, fits within the mounting recess 100 of the border element 102 and flatly abuts the viewing pane 104. The bottom edge of the backer board 96 is mounted to the border element by a horizontally-oriented hinge (not within view) that allows the board 96 to pivot vertically between an open position (shown in FIGS. 17 and 18) and a closed position (with the board 96 parallel to the border element 102 shown in FIG. 16 in exploded form). The storage compartment 98 is substantially identical to the storage compartments 28 and 93 in the embodiments described above, although it is not accessible when the backer board 96 is in the closed position. The hinge can be a piano hinge or any conventional pivoting structure.

As shown in FIGS. 16 and 18, a spring-loaded latch 106 is mounted to the rear surface of the backer board 96 adjacent the top edge of the board 96. The latch 106 has a mounting portion 108 and a movable locking tab 110. The mounting portion 108 is rigidly affixed to the backer board 96 by two pins 112 and 114, although all other means of affixing the mounting portion 108 to the board 96, such as by adhesives or screws, are contemplated. The locking tab 110 has an upwardly-extending tongue 116 for matingly engaging a slot (not within view) in the downward-facing interior surface of the shoulder 118. When the backer board 96 is in the closed position, the locking tab 110 can be slid downward relative to the mounting portion 108 to an unlocked position, in which the tongue is withdrawn from the slot, or upward to a locked position, in which the tongue engages the slot, thereby preventing the backer board 96 from pivoting relative to the border element 102. A latch spring (not within view) biases the locking tab 110 toward the locked position. A notch 126 in the bottom edge of the locking tab 110 allows the tab 110 to easily fit over a support member, such as a nail, screw, or similar structure.

In order to insert a picture 120 into the frame 122 for display, the locking tab 110 is manually pushed or pulled downward with sufficient force to overcome the latch spring. Once the tab 110 is in the unlocked position, the latch 106 is pulled backward and downward along an arc, thereby causing the attached backer board 96 to pivot to the open position, as shown in FIGS. 17 and 18. The picture 120 is then placed behind the viewing pane 104 with its viewable face seating against the pane 104. While manually holding the locking tab 110 in the unlocked position, the backer board 96 is then pivoted back to the closed position, after which the locking tab 110 is allowed to return to the locked position. When the backer board 96 is in the closed position, the picture 120 is held in a narrow gap between the compartment 98 and the viewing pane 104, and the compartment wall 105 of the storage compartment 98 presses the picture 120 flat against the viewing pane 104.

A conventional necktie-shaped easel 124 can be pivotably mounted to the rear of the backer board 96. The easel 124 can support the frame 122 in an upright position when the frame 122 is in a portrait orientation and a landscape orientation when resting on a horizontal surface. For hanging the frame 122 from a wall or other vertical surface, the easel 124 is retracted. It is contemplated that a U-shaped easel or an L-shaped easel, such as the easels 18 and 80 described above, could alternatively be used to support the frame 122. A memory label 128, such as the memory label 76 described above, is mounted to the rear of the backer board 96 for recording the contents of the storage compartment 98.

With respect to FIGS. 1-18, many components of the illustrated picture frame 10, such as the primary viewing apertures, the secondary viewing apertures, the mounting recesses, the viewing panes, the display pockets, and the storage pockets, have been described and/or shown as rectangular in shape. It is contemplated, however, that these components can have any other shape, including, but not limited to, square, circular, oval, triangular, heart, star, n-gon, and any other geometric or irregular shape.

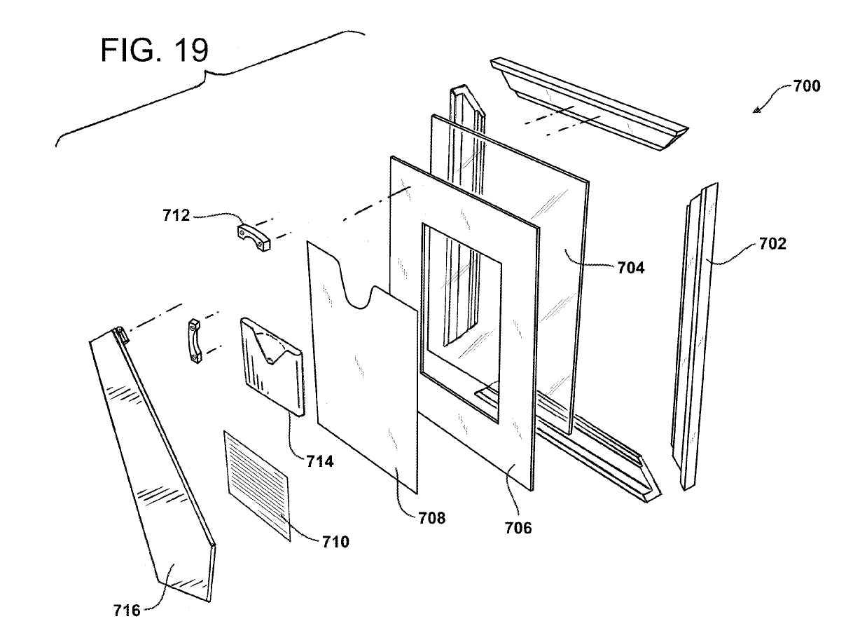

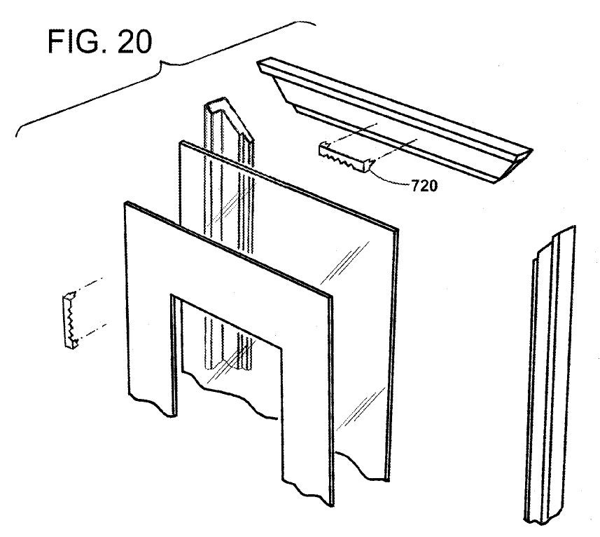

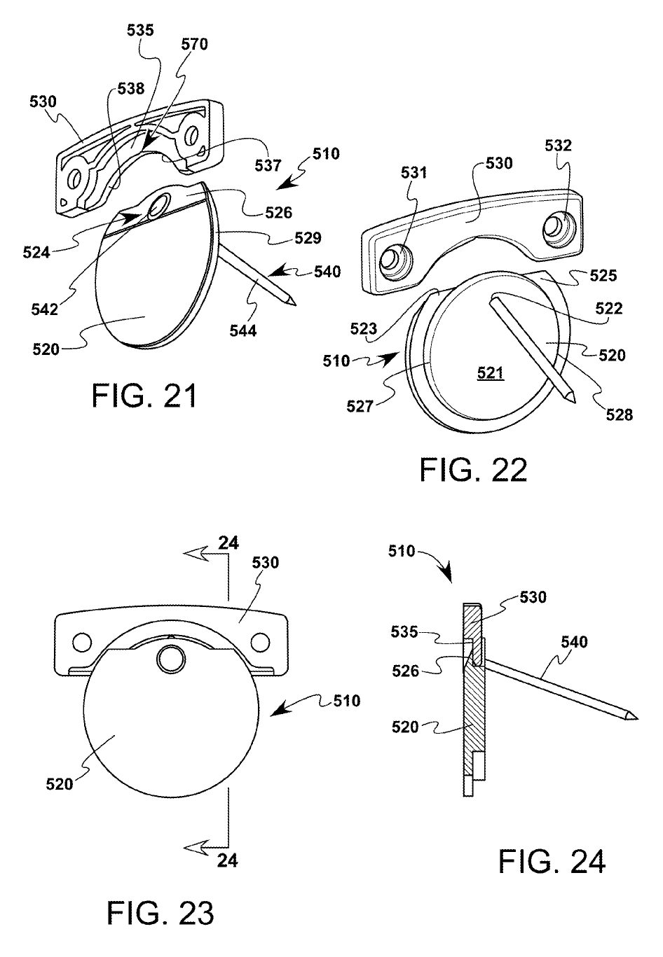

Referring to FIGS. 21-45, a hanging apparatus 510 is shown that can be used in combination with any of the frames described above, as well as with numerous other frames as will be understood by those skilled in the art. The hanging apparatus 510 has a plate 520, a hanger 530 and a fastener, such as the nail 540. The plate 520 is preferably a flat sheet of relatively strong material, such as plastic, metal, wood or a composite material, and has an aperture 522 near its upper edge, as shown in FIGS. 21 and 22. The nail 540 has a shaft 544 that extends through the aperture 522 and into a wall, as described further below. The nail head 542 seats in a recess 524 formed on one side of the aperture 522, causing the top of the nail head to lie essentially flush with, or slightly above, the plane of the surface in which the aperture 522 is formed.

The plate 520 has a chamfered edge 526 formed on its upper end as shown in FIGS. 21, 27 and 28. This edge 526 is angled relative to the parallel, major faces of the plate 520 by approximately 20 degrees, although the angle can vary between a few degrees and almost 90 degrees. The chamfered edge 526 permits the nail to be driven with its head flush with the edge 526 while the installer strikes the nail with a hammer at a natural angle. The chamfer reduces the likelihood that a strike on the plate with the hammer will fracture or destroy the plate.

The aperture 522 and the recess 524 are formed through the edge 526, and the axis of the aperture 522 is perpendicular to the plane of the edge 526 so that the nail head 542 remains parallel to the plane of the edge 526 when the nail is driven through the aperture 522. The angled aperture 522 holds the nail 540 at an angle relative to the wall that is essentially the same as the angle that the edge 526 makes relative to the major faces of the plate 520. This downwardly angling secures the nail in the wall with much more holding power than if the nail were perpendicular to the plate 520, because as weight is placed on the plate 520, the nail is pulled in a direction that has a component of force along its length, rather than perpendicular to its shaft. The angled nail also reduces rotation of the plate once the nail is hammered into the wall.

Locating the aperture 522 at one edge of the plate 520 permits the user to hold the nail during hammering into the wall by simply gripping the opposite edge of the plate 520. This avoids the need to grip the nail head 542 or shaft, thereby reducing the likelihood of injury if the nail is missed.

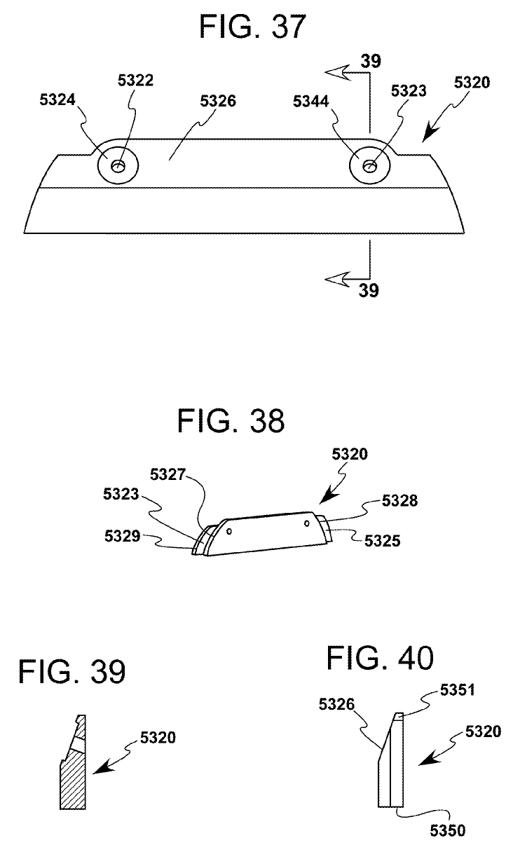

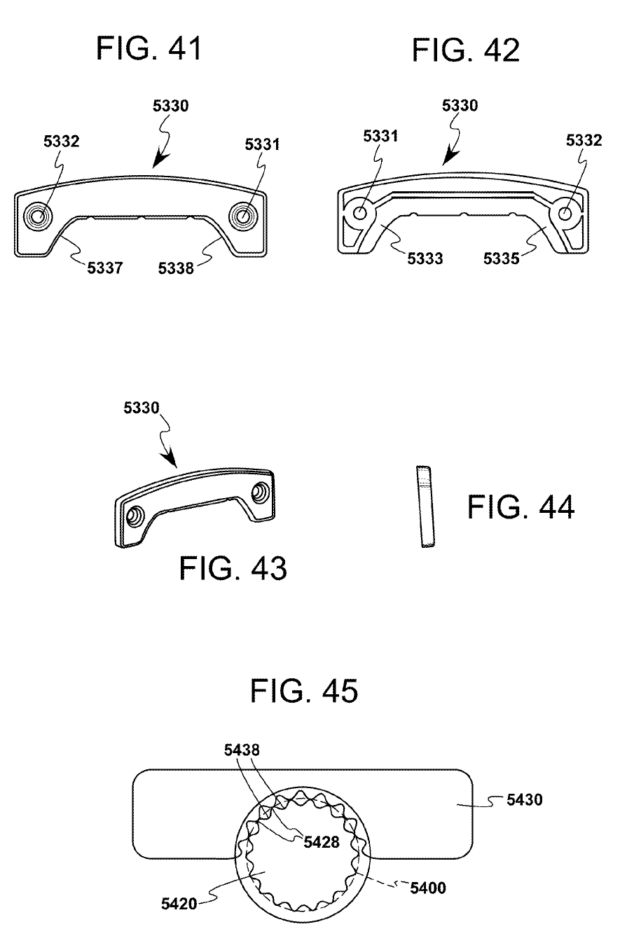

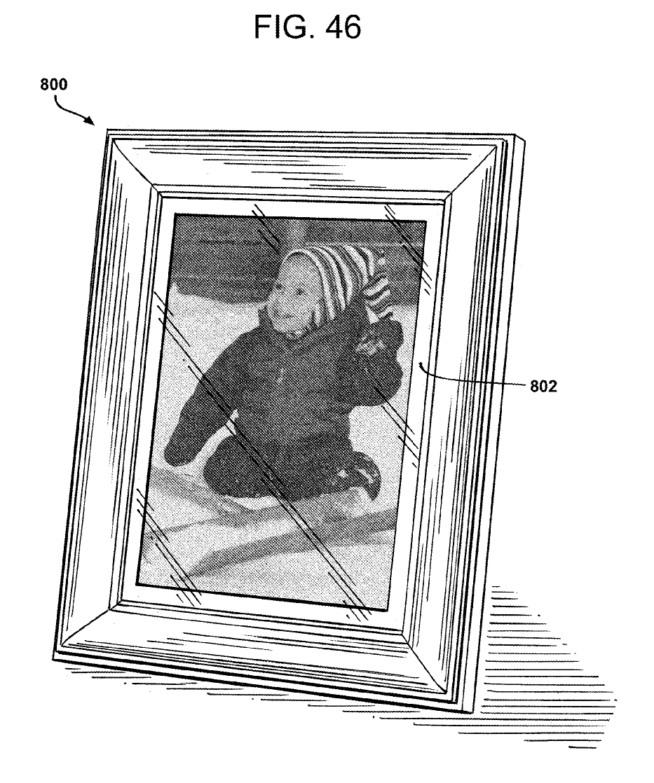

Radially outwardly facing substantially circular cylindrical surfaces 527 and 528 are formed radially inwardly of the peripheral edge 529 of the plate 520 to form a rim that will seat against complementary surfaces on the hanger 530. The surfaces 527 and 528 extend circumferentially around the plate 520 from the thinnest edge of the plate 520 to the opposite edge of the plate. As explained below in relation to FIGS. 37 and 41, the substantially circular, cylindrical surfaces could extend only partially around the plate. The surfaces 527 and 528 are preferably smooth, but can be formed by a plurality of radially outwardly extending tips positioned circumferentially around a portion of the plate 520 so long as the tips are aligned substantially along a circle (as shown in FIG. 45).

The lips 523 and 525 extend circumferentially from the intersection of the chamfered edge 526 and the surfaces 527 and 528 downwardly toward the opposite edge of the plate 520. The lips 523 and 525 extend radially outwardly from the surfaces 527 and 528 to the peripheral edge 529. As will be discussed further below, the lips 523 and 525 prevent the plate 520 from moving axially relative to the hanger 530, and could extend only partially around the plate 520 circumferentially, because it is the portions of the lips 523 and 525 nearest the edge 526 that contact, and therefore cooperate with, the hanger 530.

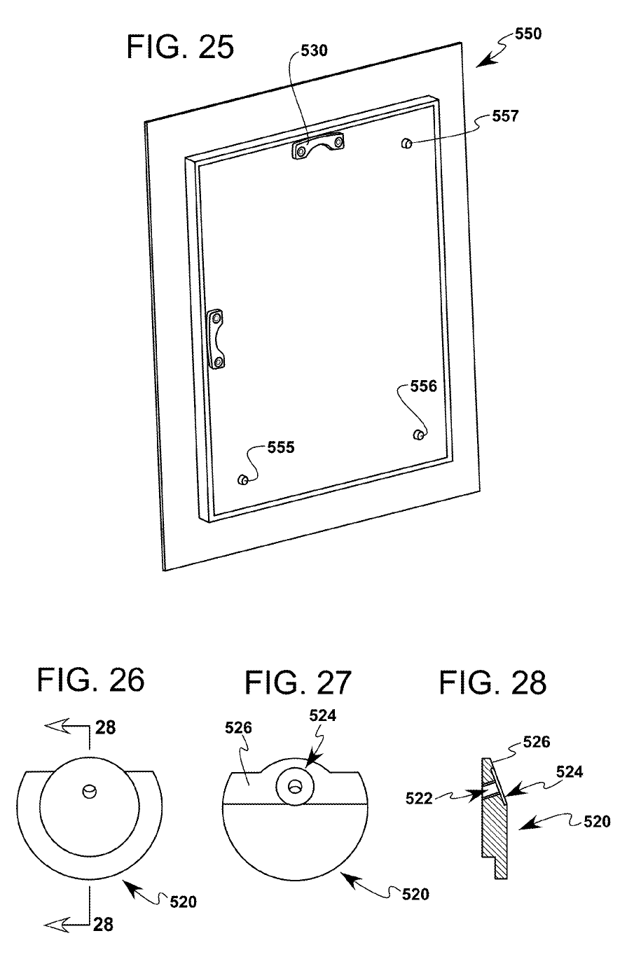

The hanger 530 is a relatively strong material, including, but not limited to, plastic, metal, wood or a composite material, and has a pair of apertures 531 and 532 through which fasteners, such as screws, extend into the frame that is to be hung. One example of the positioning of the hanger 530 on a frame is shown in FIG. 25. Of course, the hanger can be placed in other locations on frames. Additionally, other fasteners can be used to mount the hanger 530 to a frame, as will be understood by the person having ordinary skill, and these include, but are not limited to, nails, staples, adhesives, frictional engagement, etc. The frames with which the present hanging apparatus works include, but are not limited to, picture frames, plaques, easels and any other rigid, substantially planar structure that is to be displayed from a wall.

The hanger 530 has radially inwardly-facing substantially circular cylindrical surfaces 537 and 538, forming a shoulder for seating against the surfaces 527 and 528, respectively, of the plate 520. The lip 535 is formed by the portion of the hanger 530 that extends radially outwardly of the surfaces 537 and 538. The lip 535 seats against the lips 523 and 525 of the plate 520 as described below.

The hanging apparatus can be utilized in the following manner. The plate 520 is attached to a wall by placing the plate 520 in the desired position on the wall, preferably with the aperture 522 positioned at the top. The rear surface 521 (see FIG. 22) is placed against the wall, the nail 540 is inserted into the aperture 522 and the nail is hammered into the wall while the user grips the plate at the edge opposite the edge 526. Once the nail 540 is installed with its head seated against the recess 524, the plate 520 is securely fixed to the wall.

The hanger 530, if it is not already mounted to a frame, such as in the manner shown in FIG. 25, is mounted to the back of a frame, preferably near the top edge and preferably centered. The frame is then placed with its back to the wall on which the plate 520 is mounted, the hanger 530 is placed as close to directly above the plate 520 as possible, and then the frame is slid downwardly until the plate 520 is inserted into the hanger 530 with the lips 523 and 525 of the plate 520 extending behind the lip 535 of the hanger 530 as shown in FIGS. 23 and 24.

During hanging, there is a positive and palpable engagement of the hanger with the plate, and this engagement remains until the frame is deliberately lifted from the plate. If, during installation, the cylindrical surfaces 537 and 538 on the hanger 530 are not perfectly aligned with the cylindrical surfaces 527 and 528 on the plate 520, downward movement of the frame will cause the cylindrical surfaces of one structure to slide along and down the cylindrical surfaces of the other, thereby aligning the hanger on the plate. This self-aligning feature causes the hanging apparatus to make hanging a frame much easier than with the prior art. This self-alignment could be aided by additional chamfered surfaces to create a funneling effect, but need not.

When the frame is in the mounted position, the surfaces 537 and 538 rest upon the surfaces 527 and 528, respectively. Because the contacting regions of both pairs of surfaces are substantially circular cylindrical, there is contact along the interfacing surfaces, which are along at least a portion of a circle, thereby permitting rotation of the hanger 530 relative to the plate 520 by the surfaces 537 and 538 sliding against the surfaces 527 and 528. Because the surfaces 527, 528, 537 and 538 are all substantially circular cylinders, they slide relative to one another without disrupting the position of the frame 550 on the wall. Furthermore, during rotation of the frame 550, the contacting surfaces remain in contact. Thus, if the frame is not level initially, it can simply be rotated around the plate's surfaces until it is. Even if the plate 520 is installed slightly cocked to one side, the hanger 530 can be rotated a significant amount, in a range of about 30 to 60 degrees, until the frame is level. This is due to the substantially circular cylindrical surfaces that rest against one another. It should be noted that the large surface areas in contact with one another create substantial friction across the interface, thereby resisting any rotational movement of the hanger relative to the plate that can easily be overcome by a person's hand, but is not easily overcome by the force of gravity. This permits the frame to be hung slightly misaligned from the plate, if desired, or if the plate is installed rotated from its ideal orientation.

When the surfaces 537 and 538 rest upon the surfaces 527 and 528, the lips 523 and 525 seat against, or are positioned adjacent to, the lip 535. This positioning of the lips prevents axial movement (axial movement is in the direction substantially perpendicular to the wall) of the hanger from unseating the hanger 530 from the plate 520. Thus, the lips 523, 525 and 535 require the frame to be raised before the hanger 530 can come unhooked from the plate 520.

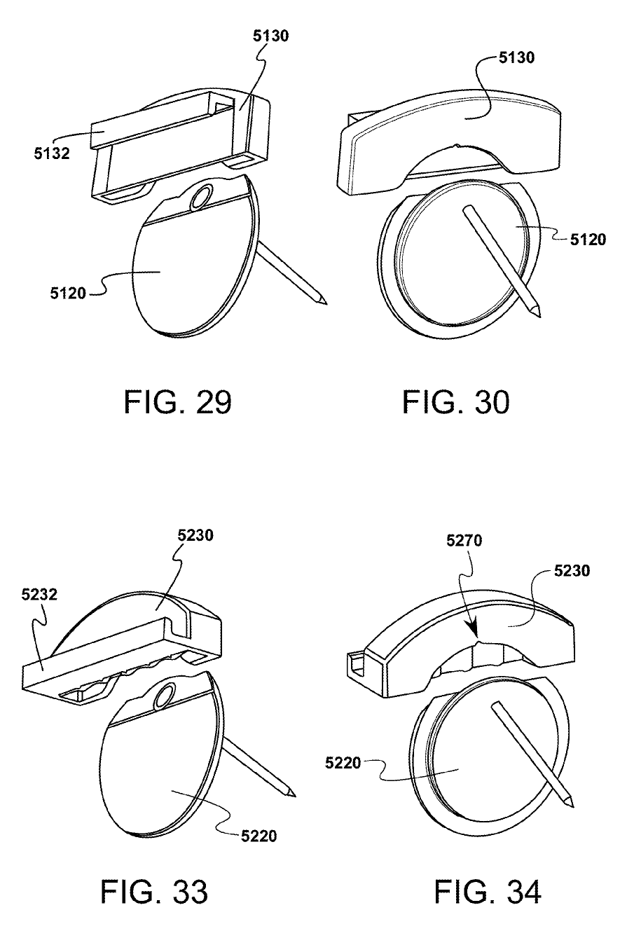

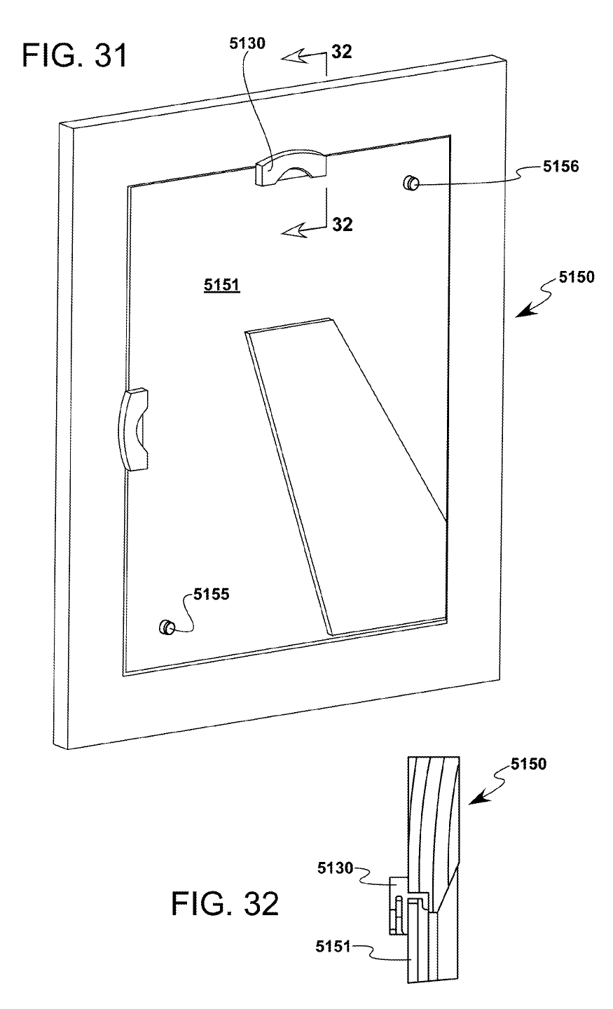

The hanging apparatus can be embodied in many different structures. Some other embodiments of the hanging apparatus are shown in FIGS. 29 through 36. FIGS. 29 and 30 show a plate 5120 that is similar to the plate 520. The hanger 5130 is substantially similar to the hanger 530, except that it is attached to a frame not by fasteners extending through apertures, but by a finger 5132. The finger 5132 extends between the frame 5150 and the backer board 5151, as shown in FIGS. 31 and 32, and is held in place by frictional engagement and by the backer board 5151 blocking its exit when the backer board 5151 is mounted in the frame 5150. The backer board 5151 may have to be notched in order to accommodate the thickness of the hanger 5130, and the hanger 5130 can be removed easily from the frame when not being used.

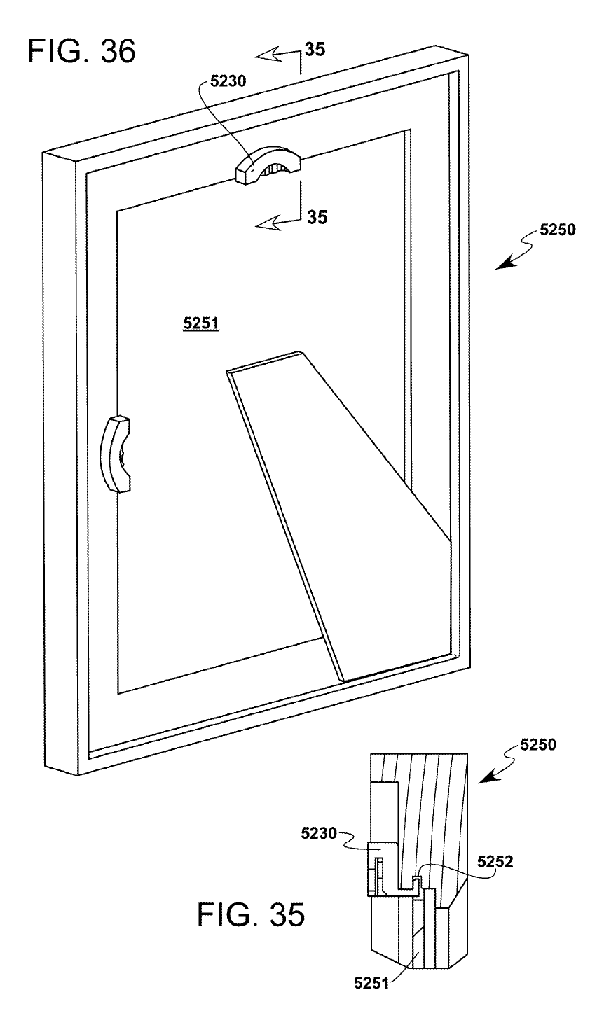

FIGS. 33 and 34 show a plate 5220, which is similar to the plate 520. The hanger 5230 is substantially similar to the hanger 530, except that the hanger 5230 is attached to a frame not by fasteners extending through apertures, but by a finger 5232. The finger 5232 extends into a slot 5252 formed in the frame 5250 adjacent to the backer board 5251, as shown in FIGS. 35 and 36, in the manner of a hook. This attachment makes the hanger 5230 easily removable.

There are many other possible structures that can attach a hanger to a frame, and they are too numerous to list. However, the person having ordinary skill is aware of these structures, including forming the hanger, or its functional components, integral with a frame.

The plate 520 and hanger 530 are designed without a specific size requirement. For example, the plate 520 can be one inch in diameter, and the hanger 530 can be approximately 1.5 inches long. Alternatively, the plate 520 can be three inches in diameter, and the hanger 530 can be 4 inches long. However, in such a large device, a large portion of the surfaces that cooperate may not be necessary, resulting in a large amount of material being wasted if the plate and hanger are made as shown in FIG. 21. As an alternative, a larger plate and hanger combination preferably has the configuration shown in FIGS. 37 through 44. The plate 5320 illustrated has a chamfered edge 5326 with apertures 5322 and 5323 through which nails or other fasteners can be extended to attach to a wall. The recesses 5324 and 5344 receive nail or screw heads, and the chamfered edge 5326 accommodates a hammer head just like the chamfered edge 526 on the plate 520. The use of two apertures permits a stronger attachment to the wall for this larger plate 5320.

The radially outwardly facing substantially circular cylindrical surfaces 5327 and 5328 are formed radially inwardly of the peripheral edge 5329 of the plate 5320. The surfaces 5327 and 5328 extend circumferentially around the plate 5320 from the thinnest edge 5351 of the plate 5320 to the lower, flat edge 5350 of the plate (see FIG. 40).

The lips 5323 and 5325 are formed at the intersection of the thinnest edge 5351 and the surfaces 5327 and 5328, and extend circumferentially downwardly to the opposite edge 5350 of the plate. The lips 5323 and 5325 also extend radially outwardly from the surfaces 5327 and 5328 to the peripheral edge 5329. As with the lips in the embodiment illustrated in FIGS. 21-22, the lips 5323 and 5325 prevent the plate 5320 from moving axially relative to the hanger 5330.

The hanger 5330, shown in FIGS. 41-44, has a pair of apertures 5331 and 5332 through which fasteners, such as screws, extend into the frame that is to be hung. Of course, other fasteners can be used to mount the hanger 5330 to a frame, as will be understood by the person having ordinary skill. The hanger has radially inwardly-facing substantially circular cylindrical surfaces 5337 and 5338 for seating against the surfaces 5327 and 5328, respectively, of the plate 5320. The lips 5333 and 5335 are formed by the portion of the hanger 5330 that extends radially outwardly of the surfaces 5337 and 5338. The lips 5333 and 5335 seat against the lips 5323 and 5325 of the plate 5320 when the hanger 5330 is mounted over the plate 5320.

When the frame is mounted to a wall, the surfaces 5337 and 5338 rest upon the surfaces 5327 and 5328, respectively. Because the contacting regions of both pairs of surfaces are substantially circular cylindrical, there is contiguous contact along at least a portion of a circle, thereby permitting rotation of the hanger 5330 relative to the plate 5320 by the surfaces 5337 and 5338 sliding against the surfaces 5327 and 5328. This is the same as with the plate 520 and hanger 530, even though the surfaces 5327 and 5328 of the plate 5330 are not connected, because it is the position of these cylindrical surfaces and their cooperation with the complementary surfaces 5337 and 5338 of the hanger 5330 that is critical for the hanging apparatus. Because the surfaces that contact one another are substantially circular cylindrical, rotation of the hanger 5330 relative to the plate 5320 can occur.

When the surfaces 5337 and 5338 rest upon the surfaces 5327 and 5328, the lips 5323 and 5325 seat against, or are positioned adjacent to, the lips 5333 and 5335. This positioning of the lips prevents axial movement of the hanger from unseating the hanger 5330 from the plate 5320 as in the embodiment of FIG. 21.

It is preferred that the thickness of the hanger be no greater than that necessary so that the back surface of the frame can rest against the wall when installed, as in the embodiment shown in FIG. 36. However, many frames do not have a cavity or other structure that can accommodate the hanger without the hanger protruding somewhat from the back of the frame. In such instances, a single hanger could cause the frame to hang non-parallel to the wall. This is a less desirable orientation than any other, and therefore bumpers are used to make the frame parallel to the wall. These bumpers have a thickness similar to the hanger used in association with the bumpers. For example, the bumpers 555, 556 and 557 are installed on the rear of the frame 550 shown in FIG. 25 so that the frame 550 rests parallel to the wall upon which it is mounted, even though the frame is not resting with its back seated against the wall. Additionally, bumpers 5155 and 5156 are installed on the back of the frame 5150 shown in FIG. 31 to accomplish the same result. The bumpers can be different thicknesses to accommodate easels on the backs of picture and other frames.

As noted briefly above, the cylindrical surfaces that seat against one another in order to enhance installation of the hanger on the plate, in addition to rotation of the hanger relative to the plate, can be raised tips instead of a smooth surface. For example, as illustrated in FIG. 45, the hanger 5430 is mounted on the plate 5420 when the raised tips 5438 of the hanger 5430 rest upon the raised tips 5428 of the plate 5420. This embodiment functions similarly to the embodiments described above, because the tips 5438 and 5428 are aligned along a circle 5400, thereby creating an effective cylindrical surface that operates under the same principle as the cylindrical surfaces in the embodiment of FIGS. 21 and 22.

Another feature of the hanging apparatus is the formation of a small indentation, such as the indentations 570 in FIGS. 21 and 5270 in FIG. 34, at the middle of the curved arch of the hanger. This indentation aids in use of the hanger without the plate on a conventional nail. The indentation centers the nail on the hanger.

Referring now to FIG. 19, the frame 700 has a border element 702, a viewing pane 704, a backing mat 706, a display pocket 708, a memory label 710, and a hanger 712 that are substantially identical to the border element 12, viewing pane 14, backing mat 86, display pocket 92, memory label 76, and hanger 530 described above. Additionally, the frame has a compact disc (CD) holder 714 and an easel 716.

The backing mat 706 is preferably formed of an acid-free and/or lignin-free material for aiding in the preservation of pictures displayed in the frame. The viewing pane 704 is preferably formed of a non-glare, ultraviolet light-blocking material for improved visibility through the pane 704 and for preserving pictures displayed in the frame 700. Although it is preferred that the hanger 712 be similar to the hanger 530 described above, it is contemplated that any conventional mounting device, such as the saw tooth hanger 718 shown in FIG. 20, can alternatively be used.

The CD holder 714 is similar to the storage pocket 93 described above, but is adapted to hold at least one CD instead of a plurality of pictures. A CD that is stored in the CD pocket 714 may contain, for example, digital copies of a plurality of different pictures, some or all of which may relate to the theme or subject matter of the picture that is on display in the frame. It is contemplated that the CD holder may additionally or alternatively be used to store digital video discs (DVD's), high-definition digital video discs (HDDVD's), Blu-ray Discs, or similar media.

The easel 716 is a conventional necktie-shaped easel that is pivotably mounted to the rear of the frame 700, although it is contemplated that the easel 716 may be any other structure that is adapted to hold the frame 700 upright on a flat surface in either a horizontal or vertical orientation, such as an elongated post or a triangular bracket.

Embodiments of the frame 700 are contemplated that incorporate features similar to the viewing pane 704, backing mat 706, display pocket 708, memory label 710, hanger 712, saw tooth hanger 720, CD holder 714, and easel 716 in all possible combinations and permutations. For example, an embodiment of the frame is contemplated having a viewing pane, a backing mat, a display pocket, and a hanger, but having no memory label, CD holder, or easel. Another embodiment is contemplated having a display pocket, a CD holder, a memory label, a saw tooth hanger, and an easel, but having no viewing pane or backing mat. Yet another embodiment is contemplated having only a display pocket, a backing mat, and a saw tooth hanger. Still another embodiment is contemplated having only a display pocket, a CD holder, and a hanger.

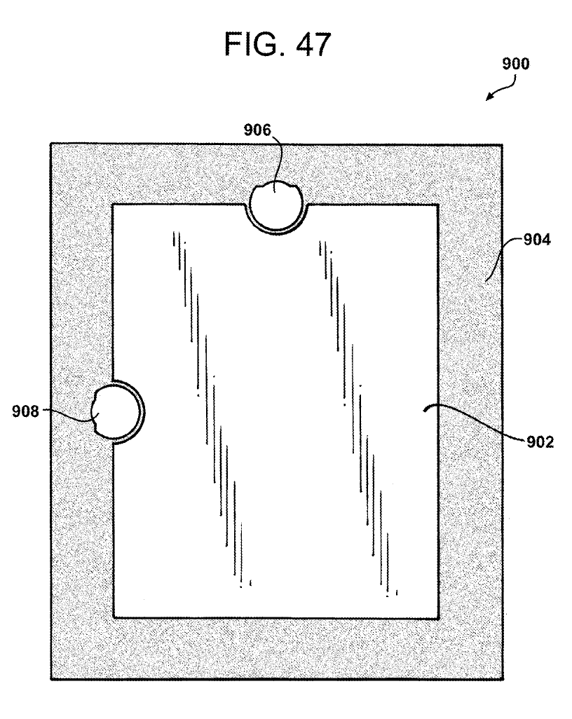

Referring now to FIG. 46, a frame 800 is shown having a slim backing mat 802. Traditional backing mats generally extend at least an inch, and typically between 1-2 inches, from an inner edge of a border element into the center of the picture. Thus, in order to frame a 5-inch by 7-inch picture with a frame that incorporates a traditional backing mat, the outer dimensions of the frame must generally be greater than 7 inches by 9 inches. In many instances, however, a person wishing to use a frame having a backing mat may only have a limited amount of space in which to display the frame.

The backing mat 802 is thus provided to accommodate situations in which a smaller overall frame size is desired. The backing mat 802 preferably extends between a picture and a border element a distance in the range of about ¼ inches to about ½ inches. Therefore, in order to frame a 5-inch by 7-inch picture, the outer dimensions of the frame can be at least about 5.5 inches by 7.5 inches, thereby saving at least 1.5 inches in both height and width compared to a frame having a traditional backing mat.

Referring now to FIG. 47, a mounting template 900 is shown that can be used in combination with any of the frames described above, as well as with numerous other conventional frames. As will be appreciated by those skilled in the art, hanging a picture frame on a wall in a desired position and in a desired orientation can be a difficult task. It is generally impossible to know precisely where a mounting device should be installed in the wall so that the frame will hang on such device as desired, because the relevant area of the wall and the rear of a frame are not within view when the frame is held against the wall. The difficulty is compounded if a plurality of picture frames must be hung in close proximity to one another in a so-called “gallery” configuration in which proper spacing and alignment of the pictures is crucial to an overall display. The template 900 is thus provided to aid in properly positioning a frame and its corresponding mounting device before the frame is hung.

The template 900 is preferably formed of a rectangular sheet of paper 902 having outer dimensions that are at least about as large as the outer dimensions of the frame that the template 900 is being used with. Printed on one side of the sheet is a border 904 that represents the size and shape of the outer edge of the border element of the frame. Also printed on the sheet are indicia outlines 906 and 908 representing the size and shape of the mounting device upon which the frame will be hung. Preferably, the mounting device being used is similar to the hanging apparatus 910 described above, although all other mounting devices, such as nails, screws, and tacks, are contemplated. The relative position of the border 904 and the outlines 906 and 908 corresponds to the relative position of the frame and the mounting device when the mounting device is mounted to a wall and the frame is hung on the mounting device in either a vertical “portrait” orientation (corresponding to outline 906) or a horizontal “landscape” orientation (corresponding to outline 908). Although it is preferred that the border 904 and the outlines 906 and 908 be printed on the template 900, it is contemplated that any other suitable means for representing the size and shape of the border element and the mounting device on the template, such as by etching, perforation, or cutouts, can alternatively or additionally be used. It is further contemplated that the template 900 can be formed of any suitable material, such as tissue paper, construction paper, parchment paper, cardboard, or sheet plastic.

To use the template 900 in a typical fashion, a user first approximates a location on a structure, such as a wall, where he would like to hang the frame. The user then temporarily mounts the template 900 to the structure using tape, pins, tacks, or similar means of temporary affixation, with the printed border 904 positioned where the user would like the border element of the frame to be positioned when the frame is hung. This simulation by the printed border 904 of the final position of the frame causes the printed border 904 of the temporarily affixed template 900 to correspond with the final frame position. Preferably, the template 900 has a pressure sensitive adhesive on the major surface opposite the indicia printed thereon. If the border 904 is not positioned as desired, the user can remove the template 900 and adjust it relative to the structure until a satisfactory placement is found. Once the border 904 is in the proper position, a mounting device, using the desired outline 906 or 908 as a guide, is mounted to the wall in a conventional manner, with a nail or other fastening means passing through the template 900 and into the wall. Thus, the outline 906 or 908 corresponds with the final, mounted position of the mounting device. The template 900 is then removed from the structure and the frame is hung on the mounting device. In order to hang a plurality of frames in a gallery configuration, a plurality of templates can be positioned and re-positioned on a structure at the same time to determine the proper relative placement of each frame and its corresponding mounting device before the frames are hung.

This detailed description in connection with the drawings is intended principally as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention and that various modifications may be adopted without departing from the invention or scope of the following claims.

1. An improved picture frame having a border element with at least one primary viewing aperture, the improvement comprising at least one display pocket mounted to a rear of the border element, said at least one display pocket configured to hold a single picture adjacent a rear of said at least one primary viewing aperture and having an opening for accepting the picture.

2. The improved picture frame of claim 1, further comprising a hanging apparatus for mounting the frame to a wall, the hanging apparatus comprising:
a. a plate having radially outwardly-facing substantially circular cylindrical surfaces;
b. a fastener for mounting the plate to the wall;
c. a hanger mounted to the frame, the hanger having radially inwardly-facing substantially circular cylindrical surfaces for seating against the substantially circular cylindrical surfaces of the plate;
d. a first lip on the plate extending radially outwardly of the substantially circular cylindrical surfaces of the plate; and
e. a second lip on the hanger extending radially outwardly of the substantially circular cylindrical surfaces of the hanger for seating against the first lip to resist plate movement beyond a predetermined limit.

3. The improved picture frame in accordance with claim 2, further comprising a chamfered plate edge adjacent the first lip.

4. The improved picture frame in accordance with claim 3, further comprising a fastener aperture formed through the chamfered plate edge for extending said fastener through.

5. The improved picture frame in accordance with claim 4, further comprising an easel having an elongated bracket with a first end pivotably mounted to a rear of the frame by at least one hinge.

6. The improved picture frame in accordance with claim 5, further comprising at least one transparent viewing pane mounted adjacent said at least one primary viewing aperture and defining a front wall of said at least one display pocket.

7. The improved picture frame in accordance with claim 6, wherein said at least one transparent viewing pane is formed of a material having ultraviolet light-blocking properties.

8. The improved picture frame in accordance with claim 6, wherein said at least one transparent viewing pane is formed of a material having anti-glare properties.

9. The improved picture frame in accordance with claim 6, further comprising at least one backing mat having at least one secondary viewing aperture, said at least one backing mat mounted between said at least one display pocket and said at least one viewing pane, said at least one display pocket mounted to a rear of said at least one backing mat.

10. The improved picture frame in accordance with claim 9, further comprising at least one storage compartment configured to hold at least one compact disc, said at least one storage compartment mounted to a rear of said at least one display pocket and having an opening for accepting said at least one compact disc.

11. The improved picture frame in accordance with claim 10, further comprising at least one memory label mounted to a rear of said at least one storage compartment for recording the contents of said at least one storage compartment.

12. The improved picture frame in accordance with claim 4, further comprising at least one transparent viewing pane mounted adjacent said at least one primary viewing aperture and defining a front wall of said at least one display pocket.

13. The improved picture frame in accordance with claim 12, wherein said at least one transparent viewing pane is formed of a material having ultraviolet light-blocking properties.

14. The improved picture frame in accordance with claim 12, wherein said at least one transparent viewing pane is formed of a material having anti-glare properties.

15. The improved picture frame in accordance with claim 12, further comprising at least one backing mat having at least one secondary viewing aperture, said at least one backing mat mounted between said at least one display pocket and said at least one viewing pane, said at least one display pocket mounted to a rear of said at least one backing mat.

16. The improved picture frame in accordance with claim 15, further comprising at least one storage compartment configured to hold at least one compact disc, said at least one storage compartment mounted to a rear of said at least one display pocket and having an opening for accepting said at least one compact disc.

17. The improved picture frame in accordance with claim 16, further comprising at least one memory label mounted to a rear of said at least one storage compartment for recording the contents of said at least one storage compartment.

18. The improved picture frame in accordance with claim 4, further comprising at least one backing mat having at least one secondary viewing aperture, said at least one backing mat mounted adjacent said at least one primary viewing aperture, said at least one display pocket mounted to a rear of said at least one backing mat.

19. The improved picture frame in accordance with claim 18, further comprising at least one storage compartment configured to hold at least one compact disc, said at least one storage compartment mounted to a rear of said at least one display pocket and having an opening for accepting said at least one compact disc.

20. The improved picture frame in accordance with claim 19, further comprising at least one memory label mounted to a rear of said at least one storage compartment for recording the contents of said at least one storage compartment.

21. The improved picture frame in accordance with claim 4, further comprising at least one storage compartment configured to hold at least one compact disc, said at least one storage compartment mounted to a rear of said at least one display pocket and having an opening for accepting said at least one compact disc.

22. The improved picture frame in accordance with claim 21, further comprising at least one memory label mounted to a rear of said at least one storage compartment for recording the contents of said at least one storage compartment.

23. The improved picture frame of claim 1, further comprising a hanging apparatus for mounting the frame to a wall, the hanging apparatus comprising a bracket having a base portion intermediate a first end and a second end, wherein the first end and the second end are mounted to a rear of the border element, the base portion having at least one serrated edge.

24. The improved picture frame in accordance with claim 23, further comprising an easel having an elongated bracket with a first end pivotably mounted to a rear of the frame by at least one hinge.

25. The improved picture frame in accordance with claim 24, further comprising at least one transparent viewing pane mounted adjacent said at least one primary viewing aperture and defining a front wall of said at least one display pocket.

26. The improved picture frame in accordance with claim 25, wherein said at least one transparent viewing pane is formed of a material having ultraviolet light-blocking properties.

27. The improved picture frame in accordance with claim 25, wherein said at least one transparent viewing pane is formed of a material having anti-glare properties.

28. The improved picture frame in accordance with claim 25, further comprising at least one backing mat having at least one secondary viewing aperture, said at least one backing mat mounted between said at least one display pocket and said at least one viewing pane, said at least one display pocket mounted to a rear of said at least one backing mat.

29. The improved picture frame in accordance with claim 28, further comprising at least one storage compartment configured to hold at least one compact disc, said at least one storage compartment mounted to a rear of said at least one display pocket and having an opening for accepting said at least one compact disc.

30. The improved picture frame in accordance with claim 29, further comprising at least one memory label mounted to a rear of said at least one storage compartment for recording the contents of said at least one storage compartment.

31. The improved picture frame in accordance with claim 23, further comprising at least one transparent viewing pane mounted adjacent said at least one primary viewing aperture and defining a front wall of said at least one display pocket.

32. The improved picture frame in accordance with claim 31, wherein said at least one transparent viewing pane is formed of a material having ultraviolet light-blocking properties.

33. The improved picture frame in accordance with claim 31, wherein said at least one transparent viewing pane is formed of a material having anti-glare properties.

34. The improved picture frame in accordance with claim 31, further comprising at least one backing mat having at least one secondary viewing aperture, said at least one backing mat mounted between said at least one display pocket and said at least one viewing pane, said at least one display pocket mounted to a rear of said at least one backing mat.

35. The improved picture frame in accordance with claim 34, further comprising at least one storage compartment configured to hold at least one compact disc, said at least one storage compartment mounted to a rear of said at least one display pocket and having an opening for accepting said at least one compact disc.

36. The improved picture frame in accordance with claim 35, further comprising at least one memory label mounted to a rear of said at least one storage compartment for recording the contents of said at least one storage compartment.

37. The improved picture frame in accordance with claim 23, further comprising at least one backing mat having at least one secondary viewing aperture, said at least one backing mat mounted adjacent said at least one primary viewing aperture, said at least one display pocket mounted to a rear of said at least one backing mat.

38. The improved picture frame in accordance with claim 37, further comprising at least one storage compartment configured to hold at least one compact disc, said at least one storage compartment mounted to a rear of said at least one display pocket and having an opening for accepting said at least one compact disc.

39. The improved picture frame in accordance with claim 38, further comprising at least one memory label mounted to a rear of said at least one storage compartment for recording the contents of said at least one storage compartment.

40. The improved picture frame in accordance with claim 39, further comprising at least one storage compartment configured to hold at least one compact disc, said at least one storage compartment mounted to a rear of said at least one display pocket and having an opening for accepting said at least one compact disc.

41. The improved picture frame in accordance with claim 40, further comprising at least one memory label mounted to a rear of said at least one storage compartment for recording the contents of said at least one storage compartment.

42. The improved picture frame in accordance with claim 1, further comprising an easel having an elongated bracket with a first end pivotably mounted to a rear of frame by at least one hinge.

43. The improved picture frame in accordance with claim 42, further comprising at least one transparent viewing pane mounted adjacent said at least one primary viewing aperture and defining a front wall of said at least one display pocket.

44. The improved picture frame in accordance with claim 43, wherein said at least one transparent viewing pane is formed of a material having ultraviolet light-blocking properties.

45. The improved picture frame in accordance with claim 43, wherein said at least one transparent viewing pane is formed of a material having anti-glare properties.

46. The improved picture frame in accordance with claim 43, further comprising at least one backing mat having at least one secondary viewing aperture, said at least one backing mat mounted between said at least one display pocket and said at least one viewing pane, said at least one display pocket mounted to a rear of said at least one backing mat.

47. The improved picture frame in accordance with claim 46, further comprising at least one storage compartment configured to hold at least one compact disc, said at least one storage compartment mounted to a rear of said at least one display pocket and having an opening for accepting said at least one compact disc.

48. The improved picture frame in accordance with claim 47, further comprising at least one memory label mounted to a rear of said at least one storage compartment for recording the contents of said at least one storage compartment.

49. The improved picture frame in accordance with claim 42, further comprising at least one backing mat having at least one secondary viewing aperture, said at least one backing mat mounted adjacent said at least one primary viewing aperture, said at least one display pocket mounted to a rear of said at least one backing mat.

50. The improved picture frame in accordance with claim 49, further comprising at least one storage compartment configured to hold at least one compact disc, said at least one storage compartment mounted to a rear of said at least one display pocket and having an opening for accepting said at least one compact disc.

51. The improved picture frame in accordance with claim 50, further comprising at least one memory label mounted to a rear of said at least one storage compartment for recording the contents of said at least one storage compartment.

52. The improved picture frame in accordance with claim 42, further comprising at least one storage compartment configured to hold at least one compact disc, said at least one storage compartment mounted to a rear of said at least one display pocket and having an opening for accepting said at least one compact disc.

53. The improved picture frame in accordance with claim 52, further comprising at least one memory label mounted to a rear of said at least one storage compartment for recording the contents of said at least one storage compartment.

54. The improved picture frame in accordance with claim 1, further comprising at least one backing mat having at least one secondary viewing aperture, said at least one backing mat mounted between said at least one display pocket and said at least one viewing pane and extending inwardly from an inner edge of the border element a distance in a range between about ¼″ and about ½″, said at least one display pocket mounted to a rear of said at least one backing mat.

55. A template for aiding in the positioning of a picture frame and a corresponding frame mounting device on a structure before the mounting device is mounted to the structure, the template comprising:
a. a sheet of material having a height and a width that are at least as large as the height and the width of the picture frame;
b. a first indicium on the sheet of a size and a shape of the picture frame to simulate the picture frame; and
c. a second indicium on the sheet of a size and a shape of the mounting device, wherein the position of the second indicium relative to the first indicium corresponds to the position of the mounting device relative to the picture frame when the mounting device is mounted to the structure and the picture frame is hung on the mounting device in a first orientation.

56. The template in accordance with claim 55, wherein the first indicium comprises a printed border and the second indicium comprises a printed outline.

57. The template in accordance with claim 55, wherein the second indicium comprises a cutout.

58. The template in accordance with claim 55, further comprising a third indicium on the sheet of a size and a shape of the mounting device, wherein the position of the third indicium to the first indicium corresponds to the position of the mounting device relative to the picture frame when the mounting device is mounted to the structure and the picture frame is hung on the mounting device in a second orientation.

59. The template in accordance with claim 58, wherein the third indicium comprises a printed outline.

60. The template in accordance with claim 58, wherein the third indicium comprises a cutout.

61. The template in accordance with claim 55, further comprising a layer of pressure sensitive adhesive on a side of the sheet opposite the indicia.

62. A method for positioning and mounting a picture frame and a corresponding mounting device to a structure, the method comprising:
a. temporarily mounting a template to the structure, the template having a first indicium of a size and a shape of the picture frame and second indicium of a size and shape of the mounting device, wherein the position of the second indicium relative to the first indicium corresponds to the position of the mounting device relative to the picture frame;
b. adjusting the position of the template until the first indicium is positioned as the border element of the frame is desired to be positioned when the frame is hung;
c. placing the mounting device over the second indicium and fastening the mounting device to the structure;
d. removing the template from the structure; and
e. hanging the picture frame on the mounting device.
